(19) United States
(12) Patent Application Publication
(10) Pub. No.: US 2014/0158793 A1
(43) Pub. Date: Jun. 12, 2014

(54) Misting Accessory

(71) Applicant: Marlon Leondrae Sims, SR., Desoto, TX (US)

(72) Inventor: Marlon Leondrae Sims, SR., Desoto, TX (US)

(21) Appl. No.: 13/918,974

(22) Filed: Jun. 16, 2013

Related U.S. Application Data
(60) Provisional application No. 61/660,750, filed on Jun. 17, 2012.

(51) Int. Cl. B05B 15/06

(52) U.S. Cl. CPC B05B 15/061
USPC 239/152

(57) ABSTRACT

A misting device/accessory to provide a misting fluid to a user may include an atomizer to atomize a fluid for the misting device/accessory, a wrist/head sleeve to connect the misting device to the user, a lower reservoir housing to connect to the wrist/head sleeve to provide a reservoir of the fluid for the atomizer and an upper reservoir housing to connect to the lower reservoir housing to cooperate with the atomizer.

### PRIORITY

The present invention claims priority under 35 USC section 119 based upon a provisional application filed on Jun. 17, 2012 with a Ser. No. of 61/660,750

### FIELD OF THE INVENTION

The present invention relates to a misting device and a wrist or head sleeve or wrap.

### BACKGROUND

In warm climates, exercising and working can result in an overheated body condition. In such climates and elsewhere, it is desirable to reduce the effects of overheating by providing a mist of cooling water. However, a source of cooling water may not be readily available.

### SUMMARY

A misting device/accessory to provide a misting fluid to a user may include an atomizer to atomize a fluid for the misting device, a wrist or head sleeve to connect the misting device to the user, a lower reservoir housing to connect to the wrist sleeve to provide a reservoir of the fluid for the atomizer and an upper reservoir housing to connect to the lower reservoir housing to cooperate with the atomizer.

The atomizer may include a flexible sphere.

The wrist or head sleeve may be expandable.

The wrist or head sleeve may include a fastener.

The upper reservoir housing may be detachably connected to the lower reservoir housing.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front exploded view of the misting device of the present invention;

FIG. 2 illustrates a front view of the misting device of the present invention;

FIG. 3 illustrates a side exploded view of the misting device of the present invention;

FIG. 4 illustrates a side view of the misting device of the present invention;

FIG. 5 illustrates a front view of the misting device and the mounting sleeve of the present invention;

FIG. 6 illustrates a side view of the misting device and the mounting sleeve of the present invention;

FIG. 7 illustrates a top view of the misting device and the mounting sleeve of the present invention;

FIG. 8 illustrates a front view of the mounting sleeve of the present invention;

FIG. 9 illustrates a front view of another misting device of the present invention.

### DETAILED DESCRIPTION

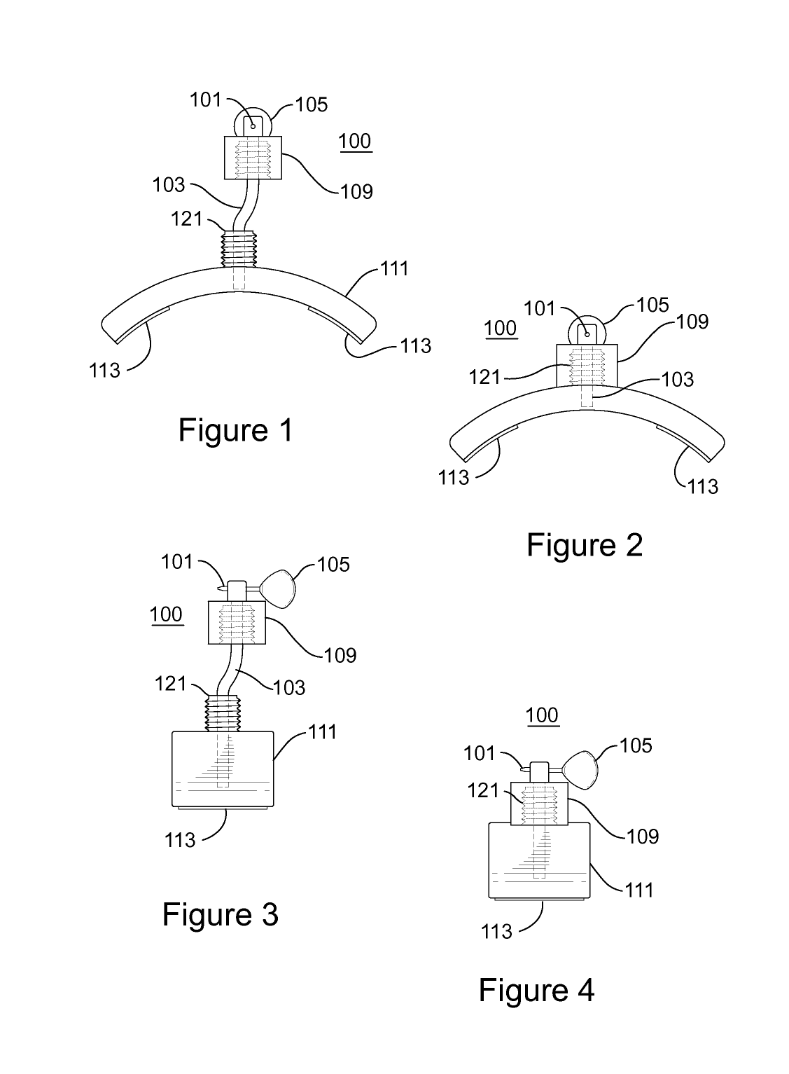

FIG. 1 illustrates a front exploded view of the misting device 100 of the present invention which may include an atomizer 105 which may be a flexible sphere which may be compressed and released to atomize a fluid which may be water or other suitable fluids through a misting valve 101. The misting valve 101 may be connected to an upper reservoir housing 109 which may be a cylinder and which may be in fluid communication with a flexible tube 103 which may be connected to the upper reservoir housing 109 and which may be in fluid communication with a lower reservoir housing 111. The lower reservoir housing 111 may be a flexible housing which may be a rectangle or other appropriate shapes and may be formed from a waterproof material such as rubber, plastic, or other appropriate materials. The lower reservoir housing 111 may include an upward extending cylinder 121 which may include male threads to threadably connect to the upper reservoir housing 109 which may include female threads to cooperate with the male threads of the lower reservoir housing 111, and the lower reservoir housing 111 may be flexible in order to cooperate with the wrist or head sleeve (or wrap) 115 (not shown in FIG. 1) which may be expandable in order to be placed on the wrist or head of a user. The lower reservoir housing 111 may include a fastener 113 which may be positioned at each corner of the lower reservoir housing 111 in order to removably and releasably connect to the wrist or head sleeve(or wrap) 115. The fastener 113 may be Velcro (hooks and loops), a snap (male and female), a button or other appropriate fasteners.

The flexible tube 103 may extend through the upper reservoir housing 109 and may extend into the lower reservoir housing 111 in order to draw the fluid which may be contained in the lower reservoir housing 111 to supply the misting valve 101 with the fluid.

FIG. 2 illustrates a front view of the misting device 100 of the present invention which may include an atomizer 105 which may be a flexible sphere which may be compressed and released to atomize a fluid which may be water or other suitable fluids through a misting valve 101. The misting valve 101 may be connected to an upper reservoir housing 109 which may be a cylinder and which may be in fluid communication with a flexible tube 103 which may be connected to the upper reservoir housing 109 and which may be in fluid communication with a lower reservoir housing 111. The lower reservoir housing 111 may be a flexible housing which may be a rectangle or other appropriate shapes and may be formed from a waterproof material such as rubber, plastic, or other appropriate materials. The lower reservoir housing 111 may include an upward extending cylinder 121 which may include male threads to threadably connect to the upper reservoir housing 109 which may include female threads to cooperate with the male threads of the lower reservoir housing 111, and the lower reservoir housing 111 may be flexible in order to cooperate with the wrist or head sleeve (or wrap) 115 (not shown in FIG. 2) which may be expandable in order to be placed on the wrist or head of a user. The lower reservoir housing 111 may include a fastener 113 which may be positioned at each corner of the lower reservoir housing 111 in order to removably and releasably connect to the wrist or head sleeve (or wrap) 115 (not shown in FIG. 1). The fastener 113 may be Velcro (hooks and loops), a snap (male and female), a button or other appropriate fasteners.

The flexible tube 103 may extend through the upper reservoir housing 109 and may extend into the lower reservoir housing 111 in order to draw the fluid which may be contained in the lower reservoir housing 111 to supply the misting valve 101 with the fluid.

FIG. 3 illustrates a side exploded view of the misting device 100 of the present invention which may include an atomizer 105 which may be a flexible sphere which may be compressed and released to atomize a fluid which may be water or other suitable fluids through a misting valve 101. The misting valve 101 may be connected to an upper reservoir housing 109 which may be a cylinder and which may be in fluid communication with a flexible tube 103 which may be connected to the upper reservoir housing 109 and which may be in fluid communication with a lower reservoir housing 111. The lower reservoir housing 111 may be a flexible housing which may be a rectangle or other appropriate shapes and may be formed from a waterproof material such as rubber, plastic, or other appropriate materials. The lower reservoir housing 111 may include an upward extending cylinder 121 which may include male threads to threadably connect to the upper reservoir housing 109 which may include female threads to cooperate with the male threads of the lower reservoir housing 111, and the lower reservoir housing 111 may be flexible in order to cooperate with the wrist or head sleeve (or wrap) 115 (not shown in FIG. 3) which may be expandable in order to be placed on the wrist or head of a user. The lower reservoir housing 111 may include a fastener 113 which may be positioned at each corner of the lower reservoir housing 111 in order to removably and releasably connect to the wrist or head sleeve (or wrap) 115 (not shown in FIG. 3). The fastener 113 may be Velcro (hooks and loops), a snap (male and female), a button or other appropriate fasteners.

The flexible tube 103 may extend through the upper reservoir housing 109 and may extend into the lower reservoir housing 111 in order to draw the fluid which may be contained in the lower reservoir housing 111 to supply the misting valve 101 with the fluid.

FIG. 4 illustrates a side view of the misting device 100 of the present invention which may include an atomizer 105 which may be a flexible sphere which may be compressed and released to atomize a fluid which may be water or other suitable fluids through a misting valve 101. The misting valve 101 may be connected to an upper reservoir housing 109 which may be a cylinder and which may be in fluid communication with a flexible tube 103 which may be connected to the upper reservoir housing 109 and which may be in fluid communication with a lower reservoir housing 111. The lower reservoir housing 111 may be a flexible housing which may be a rectangle or other appropriate shapes and may be formed from a waterproof material such as rubber, plastic, or other appropriate materials. The lower reservoir housing 111 may include an upward extending cylinder 121 which may include male threads to threadably connect to the upper reservoir housing 109 which may include female threads to cooperate with the male threads of the lower reservoir housing 111, and the lower reservoir housing 111 may be flexible in order to cooperate with the wrist or head sleeve (or wrap) 115 (not shown in FIG. 4) which may be expandable in order to be placed on the wrist or head of a user. The lower reservoir housing 111 may include a fastener 113 which may be positioned at each corner of the lower reservoir housing 111 in order to removably and releasably connect to the wrist or head sleeve(or wrap) 115 (not shown in FIG. 4). The fastener 113 may be Velcro (hooks and loops), a snap (male and female), a button or other appropriate fasteners.

The flexible tube 103 may extend through the upper reservoir housing 109 and may extend into the lower reservoir housing 111 in order to draw the fluid which may be contained in the lower reservoir housing 111 to supply the misting valve 101 with the fluid.

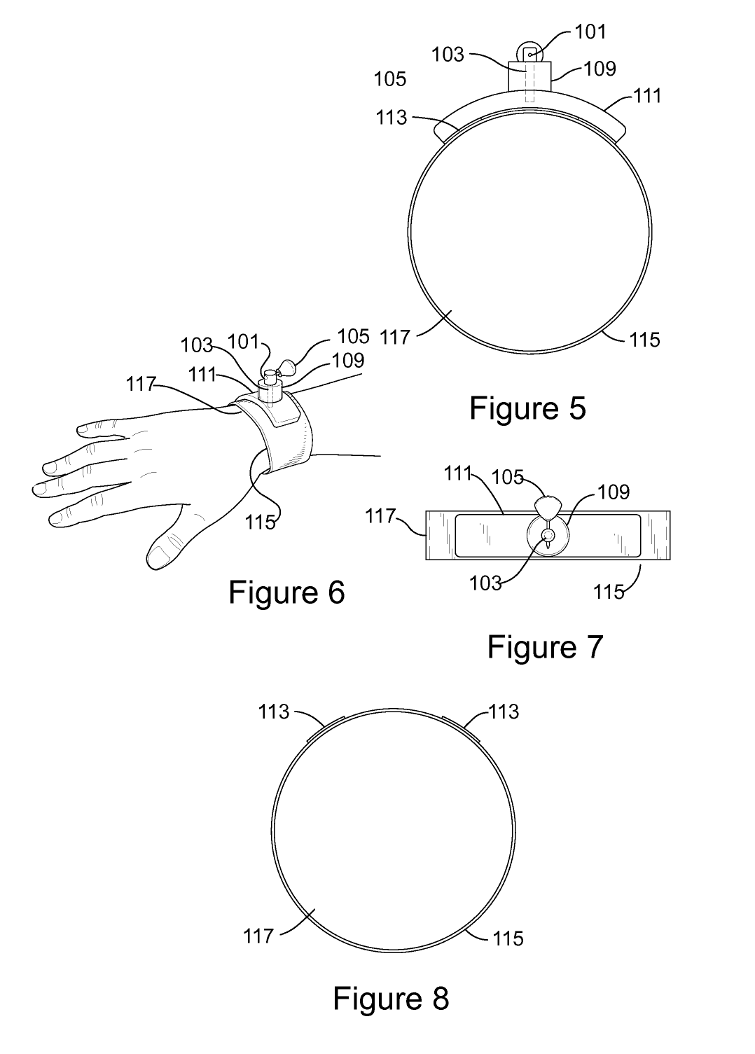

FIG. 5 illustrates a front view of the misting device 100 which may be detachably connected to the wrist or head sleeve (or wrap) 115 which may be a cylinder which may be formed from flexible and expandable material in order to extend over the hand or head of the user and be worn on the wrist or head of the user and the wrist or head sleeve (or wrap) 115 may include a central aperture 117 to cooperate with the wrist of the user. The wrist or head sleeve (or wrap) 115 may be formed from a material that absorbs moisture.

FIG. 6 illustrates a side view of the misting device 100 which may be detachably connected to the wrist sleeve (or wrap) 115 which may be a cylinder which may be formed from flexible and expandable material in order to extend over the hand of the user and be worn on the wrist of the user and the wrist sleeve (or wrap) 115 may include a central aperture 117 to cooperate with the wrist of the user. The wrist sleeve (or wrap) 115 may be formed from a material that absorbs moisture.

FIG. 6 illustrates the misting valve 101, the atomizer 105, the flexible tube 103, the upper reservoir housing 109, and the lower reservoir housing 111.

FIG. 7 illustrates a top view of the misting device 100 which may be detachably connected to the wrist or head sleeve 115 which may be a cylinder which may be formed from flexible and expandable material in order to extend over the hand or head of the user and be worn on the wrist or head of the user and the wrist or head sleeve (or wrap) 115 may include a central aperture 117 to cooperate with the wrist of the user. The wrist or head sleeve (or wrap) 115 may be formed from a material that absorbs moisture.

FIG. 7 illustrates the misting valve 101, the atomizer 105, the flexible tube 103, the upper reservoir housing 109, and the lower reservoir housing 111.

FIG. 8 illustrates a front view of the wrist or head sleeve (or wrap) 115 which may be a cylinder which may be formed from flexible and expandable material in order to extend over the hand or head of the user and be worn on the wrist or head of the user and the wrist or head sleeve (or wrap) 115 may include a central aperture 117 to cooperate with the wrist or head of the user. The wrist or head sleeve (or wrap) 115 may be formed from a material that absorbs moisture.

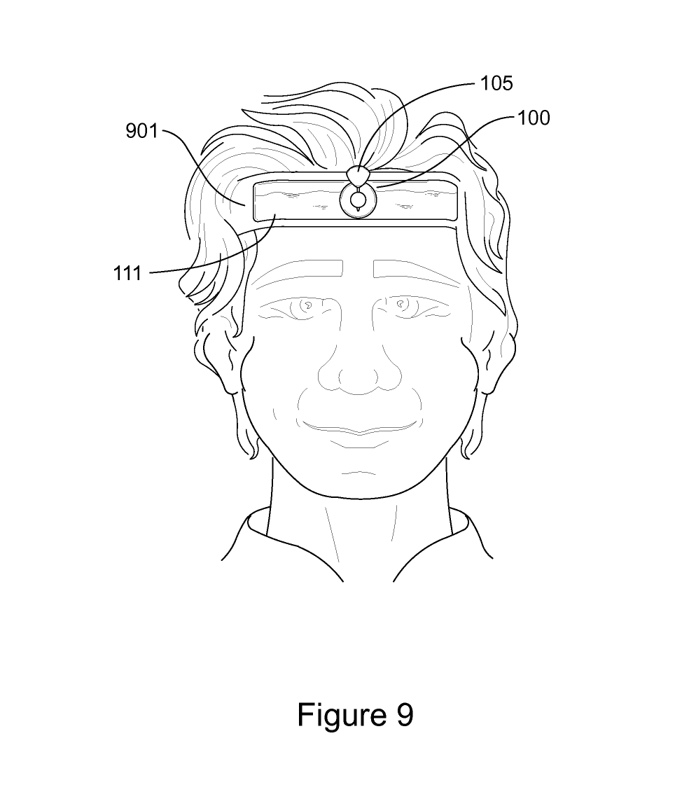

FIG. 9 illustrates a misting device/accessory 100 which may be mounted over the head of a user. The misting device/accessory 100 may include an expandable sleeve 901 to accommodate different size heads and which may retain the lower reservoir housing 111 on the head of the user.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A misting device to provide a misting fluid to a user, comprising:
an atomizer to atomize a fluid for the misting device;
a wrist sleeve to connect the misting device to the user;
a lower reservoir housing to connect to the wrist sleeve to provide a reservoir of the fluid for the atomizer;
an upper reservoir housing to connect to the lower reservoir housing to cooperate with the atomizer.

2. A misting device to provide a misting fluid to a user as in claim 1, wherein the atomizer is a flexible sphere.

3. A misting device to provide a misting fluid to a user as in claim 1, wherein the wrist sleeve is expandable.

4. A misting device to provide a misting fluid to a user as in claim 1, wherein the wrist sleeve includes a fastener.

5. A misting device to provide a misting fluid to a user as in claim 1, wherein the upper reservoir housing is detachably connected to the lower reservoir housing.

6. A misting accessory to provide a misting fluid to a user, comprising:
an atomizer to atomize a fluid for the misting accessory;
a head sleeve to connect the misting accessory to the user;
a lower reservoir housing to connect to the head sleeve to provide a reservoir of the fluid for the atomizer;
an upper reservoir housing to connect to the lower reservoir housing to cooperate with the atomizer.

7. A misting accessory to provide a misting fluid to a user as in claim 6, wherein the atomizer is a flexible sphere.

8. A misting accessory to provide a misting fluid to a user as in claim 6, wherein the head sleeve is expandable.

9. A misting accessory to provide a misting fluid to a user as in claim 6, wherein the wrist sleeve includes a fastener.

10. A misting device to provide a misting fluid to a user as in claim 6, wherein the upper reservoir housing is detachably connected to the lower reservoir housing.
